(19) United States
(12) Patent Application Publication
(10) Pub. No.: US 2019/0019203 A1
(43) Pub. Date: Jan. 17, 2019

(54) METHOD FOR PROVIDING MARKETING MANAGEMENT DATA FOR OPTIMIZATION OF DISTRIBUTION AND LOGISTICS AND APPARATUS FOR THE SAME

(71) Applicant: SK PLANET CO., LTD., Seongnam-si (KR)

(72) Inventors: Yun-Seok JANG, Seoul (KR); Woo-Hyuk JANG, Hwaseong-si (KR); Choon-Oh LEE, Suwon-si (KR); Young-Sook Hwang, Seongnam-si (KR)

(73) Assignee: SK Planet Co., Ltd.

(21) Appl. No.: 16/033,755

(22) Filed: Jul. 12, 2018

(30) Foreign Application Priority Data
Jul. 14, 2017 (KR) 10-2017-0089479

(51) Int. Cl. G06Q 30/02; G06N 7/00

(52) U.S. Cl. CPC G06Q 30/0202; G06N 7/005

(57) ABSTRACT

Disclosed herein are a method for providing marketing management data for optimization of distribution and logistics and an apparatus for the same. The method and apparatus detect, in real time, respective purchase intentions of multiple users who access an online site, generate demand forecast data, in which items and regions are taken into consideration, based on respective pieces of user information and the purchase intentions of the multiple users, and generate and provide marketing management data for optimizing distribution and logistics of multiple items provided by the online site, based on the demand forecast data. Further, information that assists item sellers in managing inventory or in managing the supply and demand of products may be provided.

### CROSS REFERENCE TO RELATED APPLICATION

This application claims the benefit of Korean Patent Application No. 10-2017-0089479, filed Jul. 14, 2017, which is hereby incorporated by reference in its entirety into this application.

### BACKGROUND OF THE INVENTION

### 1. Technical Field

The present invention relates generally to technology for analyzing, in real time, the behavior of a user occurring in Internet e-commerce and providing analyzed behavior data as marketing data, and more particularly, to technology that can analyze a continuous behavior flow, such as navigating a page or clicking a button, together with the features of items or categories related to the continuous behavior flow, and that can then provide data usable to optimize the management of distribution and logistics.

### 2. Description of the Related Art

Generally, an analysis scheme for Internet e-commerce serves to analyze the behavior of a customer with respect to a specific product or a specific Uniform Resource Locator (URL) and provide the results of analysis in the form of a profile. Such analysis is intended to arrange the behavior of a customer with respect to a specific product or category in the form of keywords used to search for products, clicked products among arranged products, and actions on pages of the clicked products (e.g. addition to a wish list, reading reviews, checking a Question and Answer (Q&A) section, addition to a shopping cart, etc.), and to sum up these actions and create data from products or categories with high scores. Also, calculated data may also be combined and provided based on the past purchase history of individual customers.

### PRIOR ART DOCUMENTS

### Patent Documents

(Patent Document 1) Korean Patent Application Publication No. 10-2017-0043259, Date of publication: Apr. 21, 2017 (entitled “Automated Real-Time Marketing System Based on Series of Actions on Webpage of Site Visitor”)

### SUMMARY OF THE INVENTION

Accordingly, the present invention has been made keeping in mind the above problems occurring in the prior art, and an object of the present invention is to detect an item to be purchased by a user or the purchase intention of the user, such as a purchase probability, before the user takes a purchasing activity via Internet e-commerce.

Another object of the present invention is to forecast demand for items, provided via Internet e-commerce, for respective item types or regions.

A further object of the present invention is to optimize a process for distribution and logistics by forecasting demand for respective items.

Yet another object of the present invention is to support Internet e-commerce so that an Internet e-commerce seller can desirably manage inventory or manage the supply and demand of products.

In accordance with an aspect of the present invention to accomplish the above objects, there is provided a method for providing marketing management data, including detecting, in real time, respective purchase intentions of multiple users who access an online site; generating demand forecast data, in which items and regions are taken into consideration, based on respective pieces of user information and the purchase intentions of the multiple users; and generating and providing marketing management data for optimizing distribution and logistics of multiple items provided by the online site, based on the demand forecast data.

The purchase intentions may include purchase intention profiles, corresponding to features of respective items desired to be purchased by the multiple users, and respective purchase probabilities of the multiple users.

Detecting the purchase intentions may include collecting respective pieces of behavior data of the multiple users on the online site; calculating respective purchase probabilities of the multiple users by comparing a purchase probability model, created based on the behavior permutations, with the behavior data; and generating respective purchase intention profiles of the multiple users based on an item database, in which pieces of item information corresponding to the multiple items are stored, and the behavior data.

Detecting the purchase intentions may further include generating the behavior permutations to correspond to continuous actions extracted based on the behavior data; and creating the purchase probability model by matching purchase results depending on the continuous actions with the behavior permutations.

Generating the demand forecast data may be configured to acquire information about respective destinations of the multiple users based on the user information and to generate at least one of pieces of demand forecast data for respective items and pieces of demand forecast data for respective regions using the purchase intention profiles, the purchase probabilities, and the destination information.

Detecting the purchase intentions may further include calculating at least one of purchase probabilities for respective items and purchase probabilities for respective item categories based on purchase probabilities that match the purchase intention profiles.

Generating the behavior permutations may be configured to generate the behavior permutations by arranging Uniform Resource Locators (URLs) corresponding to the continuous actions in temporal sequence.

The marketing management data may include pieces of purchase probability data for respective regions corresponding to each of the multiple items, the purchase probability data being generated based on the pieces of demand forecast data for respective items and the pieces of demand forecast data for respective regions.

In accordance with another aspect of the present invention to accomplish the above objects, there is provided a server, including memory for storing respective purchase intentions that are detected in real time for multiple users who access an online site; and a processor for generating demand forecast data, in which items and regions are taken into consideration, based on respective pieces of user information and respective purchase intentions of the multiple users, and for generating and providing marketing management data for optimizing distribution and logistics of multiple items provided by the online site, based on the demand forecast data.

The purchase intentions may include purchase intention profiles, corresponding to features of respective items desired to be purchased by the multiple users, and respective purchase probabilities of the multiple users.

The processor may be configured to collect respective pieces of behavior data of the multiple users on the online site, calculate respective purchase probabilities of the multiple users by comparing a purchase probability model, created based on the behavior permutations, with the behavior data, and generate respective purchase intention profiles of the multiple users based on an item database, in which pieces of item information corresponding to the multiple items are stored, and the behavior data.

The processor may be configured to generate the behavior permutations to correspond to continuous actions extracted based on the behavior data, and create the purchase probability model by matching purchase results depending on the continuous actions with the behavior permutations.

The processor may be configured to acquire information about respective destinations of the multiple users based on the user information and to generate at least one of pieces of demand forecast data for respective items and pieces of demand forecast data for respective regions using the purchase intention profiles, the purchase probabilities, and the destination information.

The processor may be configured to calculate at least one of purchase probabilities for respective items and purchase probabilities for respective item categories based on purchase probabilities that match the purchase intention profiles.

The processor may be configured to generate the behavior permutations by arranging Uniform Resource Locators (URLs) corresponding to the continuous actions in temporal sequence.

The marketing management data may include pieces of purchase probability data for respective regions corresponding to each of the multiple items, the purchase probability data being generated based on the pieces of demand forecast data for respective items and the pieces of demand forecast data for respective regions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a system for providing marketing management data for optimization of distribution and logistics according to an embodiment of the present invention;

FIG. 2 is an operation flowchart illustrating a method for providing marketing management data according to an embodiment of the present invention;

FIG. 3 is an operation flowchart illustrating an example of a procedure for creating a purchase probability model in the marketing management data provision method according to the present invention;

FIG. 4 is a diagram illustrating an example of a process for providing marketing management data according to the present invention;

FIG. 5 is a diagram illustrating examples of behavior data collected according to the present invention;

FIG. 6 is a block diagram illustrating a server for providing marketing management data according to an embodiment of the present invention;

FIG. 7 is a diagram illustrating another example of a process for providing marketing management data according to the present invention; and

FIG. 8 is a diagram illustrating an example of a procedure for learning a purchase probability model in the marketing management data provision method according to an embodiment of the present invention.

### DESCRIPTION OF THE PREFERRED EMBODIMENTS

Technical terms used in this specification are used only to describe specific embodiments, and it is to be noted that the terms are not intended to limit the present invention. Furthermore, the technical terms used in this specification should be interpreted as having meanings that are commonly understood by a person having ordinary skill in the art to which the present invention pertains, unless specifically defined otherwise in this specification, and should not be interpreted as having excessively comprehensive meanings or excessively narrow meanings. Furthermore, if the technical terms used in this specification are erroneous technical terms that do not precisely represent the spirit of the present invention, they should be replaced with technical terms that may be correctly understood by a person having ordinary skill in the art. Furthermore, common terms used in the present invention should be interpreted in accordance with the definitions of dictionaries or in accordance with the context thereof, and should not be interpreted as having excessively narrow meanings.

Furthermore, an expression of a singular number used in this specification includes an expression of a plural number unless clearly indicated otherwise by the context. In this application, terms, such as “comprise” and “include”, should not be interpreted as essentially including all of several elements or several steps described in the specification, and should be interpreted as not including some of the elements or steps or as including additional elements or steps.

Furthermore, terms including ordinal numbers, such as “first” and “second” used in this specification, may be used to describe a variety of elements, but the elements should not be limited to the terms. The terms are used to only distinguish one element from another element. For example, a first element may be named a second element, and likewise, a second element may be named a first element without departing from the scope of the present invention.

Hereinafter, preferred embodiments in accordance with the present invention are described in detail with reference to the accompanying drawings. The same or similar elements are assigned the same reference numerals irrespective of reference numerals, and a redundant description thereof is omitted.

In the following description of the present invention, detailed descriptions of known functions and configurations which are deemed to obscure the gist of the present invention will be omitted. The accompanying drawings of the present invention aim to facilitate understanding of the present invention and should not be construed as being limited to the accompanying drawings.

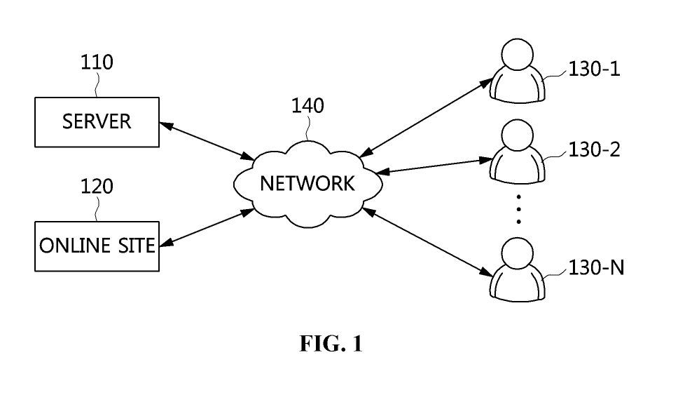

FIG. 1 is a diagram illustrating a system for providing marketing management data for optimization of distribution and logistics according to an embodiment of the present invention.

Referring to FIG. 1, the system for providing marketing management data for optimization of distribution and logistics according to the embodiment of the present invention includes a server 110, an online site 120, users 130-1 to 130-N, and a network 140.

The server 110 according to the present invention may be a device that provides marketing management data for managing distribution and logistics based on online behavior that is conducted when the users 130-1 to 130-N use e-commerce on the online site 120 based on the network 140.

The server 110 may analyze not only the behavior of the users 130-1 to 130-N with respect to a specific item or category provided by the online site 120, but also the continuous actions of the users. That is, the server 110 may analyze and learn the permutation of actions (i.e. behavior permutation) leading to the purchase of an item from the time at which each of the users 130-1 to 130-N visits an e-commerce site, and may produce a probability value from the behavior permutation.

Together with this, the meanings of actions of the users 130-1 to 130-N, which can be extracted through conventional technology, may be utilized as data related to items of interest or categories of interest to the users 130-1 to 130-N in the present invention. In other words, continuous actions of the users 130-1 to 130-N for navigating the online site 120 may be analyzed, and the extent of influence of the continuous actions exerted on a purchase may be grasped, and thus information about common items or categories revealed in the continuous actions may be profiled.

Here, unlike the conventional technology, which simply used only the details of items, the present invention may extract keywords based on brands representing items, categories of the items, etc., and information about the extracted keywords or the like may be used to analyze association between products, thus improving real-time characteristics.

Although the server 110 and the online site 120 are illustrated as being separate components in FIG. 1, the server 110 and a separate operating server for operating the online site 120 may be the same server. That is, the server 110 for providing marketing management data may be included in the operating server of the online site 120 for providing e-commerce service. Alternatively, the operating server of the online site 120 for providing e-commerce service may be included in the server 110 for providing marketing management data.

The server 110 may detect, in real time, respective purchase intentions of the multiple users 130-1 to 130-N who access the online site 120.

Here, the purchase intentions may include purchase intention profiles, corresponding to the features of respective items desired to be purchased by the multiple users 130-1 to 130-N, and respective purchase probabilities of the multiple users 130-1 to 130-N.

For each of the multiple users 130-1 to 130-N, behavior data on the online site 120 may be collected.

A purchase probability model created based on multiple behavior permutations may be compared with the behavior data, and thus respective purchase probabilities of the multiple users 130-1 to 130-N may be calculated.

Respective purchase intention profiles for the multiple users 130-1 to 130-N may be generated based on pieces of item information, which correspond to multiple items stored in an item database (DB), and the behavior data.

Here, the behavior permutations may be generated to correspond to continuous actions extracted based on the behavior data.

The behavior permutations may be generated by arranging Uniform Resource Locators (URLs) corresponding to the continuous actions in temporal sequence.

The purchase probability model may be created by matching purchase results corresponding to the continuous actions with the behavior permutations.

At least one of purchase probabilities for respective items and purchase probabilities for respective item categories may be calculated based on the purchase probabilities that match the purchase intention profiles.

The server 110 generates demand forecast data, in which items and regions are taken into consideration, based on the user information and purchase intention of each of the multiple users 130-1 to 130-N.

Here, information about respective destinations of the multiple users 130-1 to 130-N may be acquired from the user information, and at least one of pieces of demand forecast data for respective items and pieces of demand forecast data for respective regions may be generated using the purchase intention profiles, the purchase probabilities, and the destination information.

Also, the server 110 may generate and provide marketing management data for optimizing distribution and logistics of multiple items provided by the online site, based on the demand forecast data.

Here, the marketing management data may include pieces of purchase probability data for respective regions corresponding to each of the multiple items, wherein the purchase probability data may be generated based on the pieces of demand forecast data for respective items and the pieces of demand forecast data for respective regions.

The online site 120 may be an Internet site which is accessed by the multiple users 130-1 to 130-N and on which the multiple users 130-1 to 130-N use e-commerce service. In this case, the operating server for operating the online site 120 may be included in the server 110, or may be present independently of the server 110.

The users 130-1 to 130-N may be persons who access the online site 120 and engage in various types of behavior while using the e-commerce service. For example, the users 130-1 to 130-N may access the online site 120, and may engage in various types of online behavior, such as searching for items, viewing details of the items, adding items to a shopping cart, or attempting to make a payment.

Here, the users 130-1 to 130-N may access the online site 120 through user terminals, such as mobile terminals or computers, and may use the e-commerce service.

For example, each of the user terminals may be a device on which an application according to the present invention may run by being connected with a communication network, and may be any of various types of terminals including all types of information communication devices, multimedia terminals, Internal Protocol (IP) terminals, and the like, without being limited to mobile communication terminals. Also, the user terminal may be a mobile terminal having various mobile communication specifications, such as a mobile phone, a Portable Multimedia Player (PMP), a Mobile Internet Device (MID), a smartphone, a tablet PC, a laptop, a netbook, a Personal Digital Assistant (PDA), an information communication device, and the like.

Further, the user terminal may receive various kinds of information, such as numbers, letters, and the like, and may deliver signals, input for setting various functions and controlling the functions of the user terminal, to the control unit via the input unit. Also, the input unit of the user terminal may be configured so as to include at least one of a keypad and a touch pad, which generate an input signal in response to the touch or manipulation by a user. Here, the input unit of the user terminal and the display unit thereof may form a single touch panel (or a touch screen), thereby performing both an input function and a display function. Also, the input unit of the user terminal may use all types of input means that may be developed in the future as well as currently existing input devices, such as a keyboard, a keypad, a mouse, a joystick, and the like.

The display unit of the user terminal may display information about a series of operation states and operation results generated while the function of the user terminal is being performed. Also, the display unit of the user terminal may display the menu of the user terminal and user data input by a user. Here, the display unit of the user terminal may be configured with a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the user terminal is configured in the form of a touch screen, the display unit of the user terminal may perform some or all of the functions of the input unit of the user terminal. Particularly, the display unit of the user terminal according to the present invention may display an interface provided for the provision of marketing management data and information about execution of the application on a screen.

The storage unit of the user terminal may include a main storage device and an auxiliary storage device as devices for storing data, and may store applications that are necessary for the operation of the user terminal. The storage unit of the user terminal may include a program area and a data area. Here, when the user terminal activates each function in response to a request from a user, the user terminal provides the function by running corresponding applications under the control of the control unit. Particularly, the storage unit of the user terminal according to the present invention may store an Operating System (OS) for booting the user terminal, an application for sending and receiving information input for providing marketing management data, and the like. Also, the storage unit of the user terminal may store information about the user terminal and a content DB for storing multiple pieces of content. Here, the content DB may include execution data for executing content and attribute information about the content, and may store content usage information in response to the execution of the content. Also, the information about the user terminal may include the specifications of the user terminal.

The communication unit of the user terminal may function to send and receive data to and from the online site 120 over the network 140. Here, the communication unit of the user terminal may include an RF transmission medium for up-conversion and amplification of the frequency of a sending signal and an RF reception medium for low-noise amplification of a receiving signal and down-conversion of the frequency thereof. Such a communication unit of the user terminal may include a wireless communication module. Also, the wireless communication module is a component for sending or receiving data based on a wireless communication method, and may send and receive data to and from the online site 120 using any one of a wireless network communication module, a wireless LAN communication module, and a wireless PAN communication module when the user terminal uses wireless communication. That is, the user terminal may access the network 140 using a wireless communication module, and may send and receive data to and from the online site 120 over the network 140.

The control unit of the user terminal may be a processing device for running an Operating System (OS) and respective components. For example, the control unit may control the overall process of accessing the online site 120. When access to the online site 120 is made through the Internet or an application, the control unit may control the overall process of running the application in response to the request by a user, and may perform control so as to send a request for using e-commerce service to the online site 120 simultaneously with execution of the application. Here, the control unit may perform control such that information about the user terminal required for user authentication is sent along with the request.

The network 140, which provides a path through which data is transferred between the server 110, the online site 120, and the users 130-1 to 130-N, may be conceptually understood as including networks that are currently being used and networks that have yet to be developed in the future. For example, the network may be any one of wired and wireless local networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future.

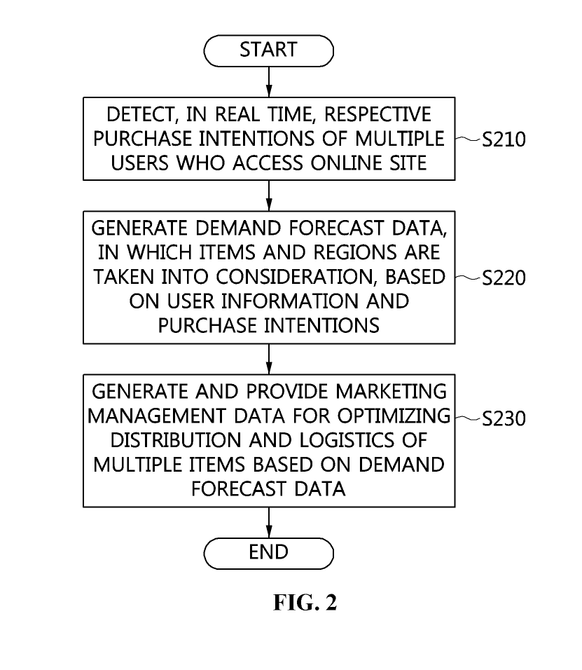

FIG. 2 is an operation flowchart illustrating a method for providing marketing management data according to an embodiment of the present invention.

Referring to FIG. 2, the marketing management data provision method according to the embodiment of the present invention detects, in real time, respective purchase intentions of multiple users who access an online site at step S210.

The present invention is intended to detect items to be purchased or the types of items and probabilities that the corresponding items will be purchased, before the multiple users who access the online site actually purchase respective items. For this function, there is a need to detect the purchase intentions of the users before the users purchase the corresponding items.

Here, the purchase intentions may include purchase intention profiles corresponding to the features of respective items desired to be purchased by the multiple users and respective purchase probabilities of the multiple users.

The purchase intention profiles according to the present invention may contain the results of analysis of brand characteristics, keyword characteristics, and price range characteristics according to the present invention, and may then be used to analyze association between the items.

Also, the purchase probabilities according to the present invention may be calculated as high values when each user takes continuous meaningful actions.

Such a purchase intention may be detected at each moment at which the corresponding user searches for an item through the online site. Therefore, the purchase intentions detected in this way may be analyzed and provided in advance before the user actually takes each purchase activity.

Here, in order to detect the purchase intentions, behavior data of the multiple users on the online site may be collected for each user.

The behavior data may be related to online actions taken by multiple users who access the online site.

For example, the online behavior may include explicit actions, such as the actions of clicking an item, reading item reviews, addition to or deletion from a shopping cart, attempting to make a payment, entering a keyword, clicking an advertisement, and the social activity of clicking the “like” button or sharing a specific page. Further, the online behavior may also include all implicit actions considered to have a possibility of forming a basis for inferring items of interest, such as user experience (UX)-related actions including a mouse wheel control or swipe-out action, or the action of staying on a specific page for a long period of time or revisiting the same item page or a similar category page. However, the online behavior is not limited to those examples.

Here, the behavior data may be collected in real time immediately when the user accesses the online site and takes actions. Further, the behavior data may be collected in the form of a stream, and may be subjected to a preprocessing procedure for enabling the behavior data to be processed as data having the format needed to detect the purchase intention of the user.

That is, all actions taken by each user who accesses the online site may be collected in real time in accordance with behavior data.

The marketing management data provision method according to the embodiment of the present invention may use the real-time online behavior (actions) of the user, as described above. That is, unlike a conventional scheme, in which an item expected to be purchased by the user is determined or in which a purchase probability for the item is predicted using the past purchase records or profile information of the user, the present invention may infer an item or a category having a strong possibility of being purchased by the user in the near future based on a behavior pattern, such as that indicating which page is currently being visited by the user within the e-commerce site currently accessed by the user. By means of this scheme, it is possible to more accurately detect the purchase intention of the user who currently accesses the online site than when using the conventional scheme.

The behavior data collected in real time may include the time at which each online action is taken, an ID for identifying the user or the user terminal, a URL visited by the user, item-related information, etc. The item-related information may include an item number or category information for identifying the corresponding item. The item-related information may also include meta-information, such as item prices or options and keywords entered by the user to search for the items, by which the degree of importance of online behavior can be determined.

Here, the paths through which the behavior data is collected are not limited to a specific path. For example, the behavior data corresponding to the online behavior of the user may be collected in real time through any of various paths, such as a mobile website, a mobile application, and a PC website.

In addition, the behavior data according to the present invention may be received in such a way that the server according to the embodiment of the present invention unifies and receives all behavior data, or in such a way that some terminals aggregate behavior data generated thereby and transfer the aggregated behavior data in a simplified form to the server. Here, the method for collecting the behavior data is not particularly limited to any specific method.

Here, a purchase probability model created based on the behavior permutations may be compared with the behavior data, and thus the respective purchase probabilities of multiple users may be calculated.

The purchase probability model may be a purchase probability model for the corresponding online site. That is, patterns may be extracted from behavior permutations collected from the online site, and the frequency at which a purchase occurs or a non-purchase occurs in the extracted patterns may be analyzed, and thus the purchase probability model may be created based on the results of analysis of the frequency.

Therefore, the behavior data collected in accordance with the user is compared with a purchase pattern or a non-purchase pattern included in the purchase probability model, and thus whether the user will purchase the corresponding item may be calculated as a probability.

Here, behavior permutations may be generated to correspond to the continuous actions extracted based on the behavior data.

The behavior permutations may be generated by arranging pieces of behavior data collected for respective users in temporal sequence depending on various criteria.

For example, it may be assumed that pieces of behavior data collected from user A are arranged depending on the item as a criterion. In this case, a behavior permutation may be generated by arranging only pieces of behavior data related to a specific item B, among pieces of behavior data that are collected when the user A takes continuous actions, in temporal sequence.

Further, when pieces of behavior data are arranged depending on the category as a criterion in the above example, a behavior permutation may also be generated by arranging only pieces of behavior data related to a specific category C, among the pieces of behavior data that are collected when the user A takes continuous actions, in temporal sequence.

Here, the behavior permutation may be generated by arranging Uniform Resource Locators (URLs) corresponding to continuous actions in temporal sequence.

For example, it may be assumed that the user accesses an e-commerce site having an address (URL) corresponding to ‘http://xxx.com’ and takes online actions. In this case, when the user sequentially navigates from a main page to an item detail page, a shopping cart page, and a payment page, a behavior permutation corresponding to (http://xxx.com/main)-(http://xxx.com/item/detail)-(http://xxx.com/basket)-(http://xxx.com/pay) may be generated.

Here, respective URLs corresponding to continuous actions may be converted into and represented by separate identifiers in order to simplify the indication and processing of behavior permutations.

In the above example, ‘http://xxx.com/main’ may be converted into URL_1, ‘http://xxx.com/item/detail’ may be converted into URL_2, ‘http://xxx.com/basket’ may be converted into URL_3, and ‘http://xxx.com/pay’ may be converted into URL_4, and thus the resulting URLs may be indicated.

Here, a behavior permutation may be generated for each session which is based on a time point at which the user accesses the online site.

In an example, a period from a time point at which the user logs in to the online site to a time point at which the user logs out from the online site may be determined to be a single session. Behavior data for online actions taken in the corresponding session may be collected, and thus a behavior permutation may be generated.

In another example, a period from a time point at which the user accesses the online site to a time point at which the user leaves the online site may be determined to be a single session, and thus a behavior permutation may be generated based on the session.

The start and end of a single session may not be limited to specific time points, but may be set to various time points.

Here, the purchase probability model may be created by matching purchase results corresponding to continuous actions with behavior permutations.

For example, the purchase probability model may be created by extracting a purchase pattern and a non-purchase pattern based on the behavior permutation of continuous actions that frequently occur when a purchase is made by multiple users who use the corresponding online site, or based on the behavior permutation of continuous actions that frequently occur when a purchase is not made by the multiple users. In this case, a behavior permutation, for which the total number of occurrences of continuous actions in each pattern does not reach a predetermined number, is excluded from the creation of the purchase probability model, and thus the computing speed at which the purchase probability model is created may be improved.

Here, respective purchase intention profiles of the multiple users may be generated based on the pieces of item information corresponding to multiple items, stored in an item DB, and the behavior data.

Here, the item DB may store item information about multiple items registered on the online site accessed by each user. For example, detailed information related to respective items, such as item names, item categories, and item prices, may be stored in accordance with the item information.

Therefore, information about an item, for which the user is determined to have a purchase intention based on the behavior data, may be acquired from the item DB, and a purchase intention profile may then be generated from the item information.

Here, purchase intention profiles may contain, but are not limited to, information such as a search term, a keyword, a brand, and a price range for the corresponding item.

Further, the purchase intention profiles may contain weights to be applied to the determination of a purchase intention in consideration of the URLs visited by each user based on the behavior data. For example, when the URL of the page visited by the user is the URL of a page in which the corresponding item is to be purchased, a weight may be applied to the purchase page, compared to the case where the URL of the page visited by the user is the URL of the main page of the online site. That is, when the user navigates to the payment page for paying for a specific item, it may be determined that the user definitely has an intention to purchase the specific item, and a weight may be applied to the payment page.

Also, at least one of purchase probabilities for respective items and purchase probabilities for respective item categories may be calculated based on the purchase probabilities that match the purchase intention profiles.

Further, the marketing management data provision method according to the embodiment of the present invention may provide user distributions for respective purchase probabilities for a specific item or a specific category based on purchase probabilities of respective users, purchase probabilities for respective items, and purchase probabilities for respective item categories which are included in purchase intentions.

Next, the marketing management data provision method according to the embodiment of the present invention generates demand forecast data, in which items and regions are taken into consideration, based on pieces of user information and purchase intentions of multiple users at step S220.

Here, information about respective destinations of the multiple users 130-1 to 130-N may be acquired from the user information, and at least one of pieces of demand forecast data for respective items and pieces of demand forecast data for respective regions may be generated using the purchase intention profiles, the purchase probabilities, and the destination information.

For example, the pieces of demand forecast data for respective items may be data indicating how many users have purchase intentions for each of multiple items, and the pieces of demand forecast data for respective regions may be data indicating how many users have purchase intentions in each of multiple regions.

The user information may be acquired from a separate DB which stores user information on the online site.

Thereafter, the marketing management data provision method according to the embodiment of the present invention generates and provides, based on the demand forecast data, marketing management data for optimizing distribution and logistics of multiple items provided by the online site at step S230.

Here, the marketing management data may include pieces of purchase probability data for respective regions corresponding to each of multiple items, wherein the purchase probability data may be generated based on the pieces of demand forecast data for respective items and the pieces of demand forecast data for respective regions. Since the pieces of purchase probability data for respective regions corresponding to each of multiple items may include destination information, demand in respective regions for the corresponding item may be forecasted when the purchase probabilities are divided according to region.

Therefore, the marketing management data may be provided to individual item sellers based on the online site, thus allowing the sellers to effectively perform inventory management for items having a high purchase probability. Further, the distribution and logistics of items may be optimized in terms of purchase probabilities for respective regions or demand for respective regions such that the distribution and logistics of the items are not disrupted.

Furthermore, although not illustrated in detail in FIG. 2, the marketing management data provision method according to the embodiment of the present invention may transmit and receive information needed to provide marketing management data over a communication network, such as a typical network. In particular, data about the online behavior of each user may be received from a separate server for operating the online site.

In addition, although not illustrated in detail in FIG. 2, the marketing management data provision method according to the embodiment of the present invention may store various types of information, generated during the above-described marketing management data provision process, in a separate storage module.

By means of this marketing management data provision method, an item to be purchased by a user or the purchase intention of the user, such as a purchase probability, may be detected before the user takes a purchasing activity via Internet e-commerce.

Further, demand for items, provided via Internet e-commerce, may be forecasted for respective item types or regions.

Furthermore, a process for distribution and logistics may be optimized by forecasting demand for respective items.

In addition, Internet e-commerce may be supported so that an Internet e-commerce seller can desirably manage inventory or mange the supply and demand of products.

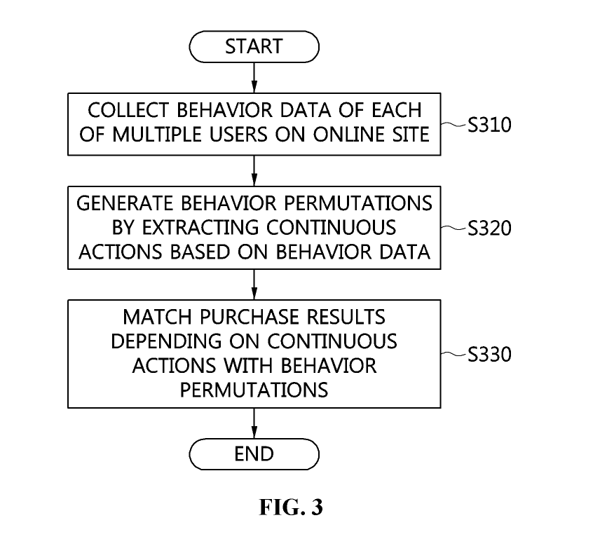

FIG. 3 is an operation flowchart illustrating an example of a procedure for creating a purchase probability model in the marketing management data provision method according to the present invention.

Referring to FIG. 3, the procedure for creating a purchase probability model in the marketing management data provision method collects behavior data of each of multiple users on the online site at step S310.

The behavior data may be related to online actions taken by multiple users who access the online site.

For example, the online behavior may include explicit actions, such as the actions of clicking an item, reading item reviews, addition to or deletion from a shopping cart, attempting to make a payment, entering a keyword, clicking an advertisement, and the social activity of clicking the “like” button or sharing a specific page. Further, the online behavior may also include all implicit actions considered to have a possibility of forming a basis for inferring items of interest, such as user experience (UX)-related actions including a mouse wheel control or swipe-out action, or the action of staying on a specific page for a long period of time or revisiting the same item page or a similar category page. However, the online behavior is not limited to those examples.

Here, the behavior data may be collected in real time immediately when the user accesses the online site and takes actions. Further, the behavior data may be collected in the form of a stream, and may be subjected to a preprocessing procedure for enabling the behavior data to be processed as data having the format needed to detect the purchase intention of the user.

Here, the behavior data collected in real time may include the time at which each online action is taken, an ID for identifying the user or the user terminal, a URL visited by the user, item-related information, etc.

Next, behavior permutations are generated by extracting continuous actions based on the behavior data at step S320.

Here, the behavior permutations may be generated by arranging pieces of behavior data collected for respective users in temporal sequence depending on various criteria.

For example, it may be assumed that pieces of behavior data collected from user A are arranged depending on the item as a criterion. In this case, a behavior permutation may be generated by arranging only pieces of behavior data related to a specific item B, among pieces of behavior data that are collected when the user A takes continuous actions, in temporal sequence.

Further, when pieces of behavior data are arranged depending on the category as a criterion in the above example, a behavior permutation may also be generated by arranging only pieces of behavior data related to a specific category C, among the pieces of behavior data that are collected when the user A takes continuous actions, in temporal sequence.

Here, the behavior permutation may be generated by arranging Uniform Resource Locators (URLs) corresponding to continuous actions in temporal sequence.

Here, respective URLs corresponding to continuous actions may be converted into and represented by separate identifiers in order to simplify the indication and processing of behavior permutations.

Each behavior permutation may be generated for each session which is based on a time point at which the user accesses the online site.

In an example, a period from a time point at which the user logs in to the online site to a time point at which the user logs out from the online site may be determined to be a single session. Behavior data for online actions taken in the corresponding session may be collected, and thus a behavior permutation may be generated.

In another example, a period from a time point at which the user accesses the online site to a time point at which the user leaves the online site may be determined to be a single session, and thus a behavior permutation may be generated based on the session.

Thereafter, purchase results depending on continuous actions match the behavior permutations at step S330.

For example, the purchase probability model may be created by extracting a purchase pattern and a non-purchase pattern based on the behavior permutation of continuous actions that frequently occur when a purchase is made by multiple users who use the corresponding online site, or based on the behavior permutation of continuous actions that frequently occur when a purchase is not made by the multiple users. In this case, a behavior permutation, for which the total number of occurrences of continuous actions in each pattern does not reach a predetermined number, is excluded from the creation of the purchase probability model, and thus the computing speed at which the purchase probability model is created may be improved.

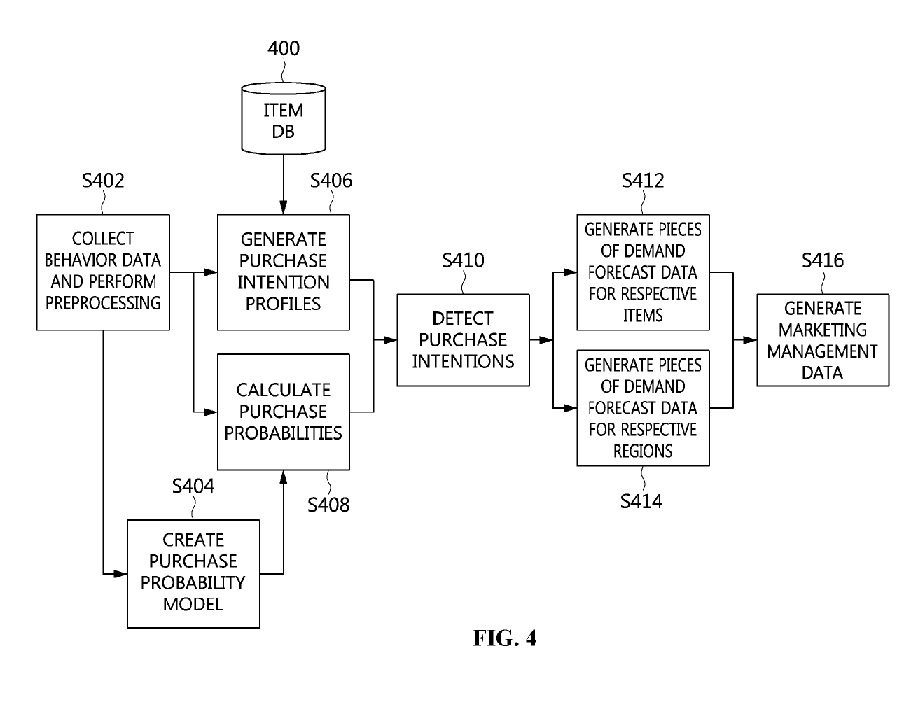

FIG. 4 is a diagram illustrating an example of a process for providing marketing management data according to the present invention.

Referring to FIG. 4, the process for providing marketing management data according to the present invention may collect behavior data corresponding to the online behavior of multiple users who access the online site, and may perform preprocessing on the behavior data so as to use the behavior data to detect purchase intentions.

Here, the behavior data may be collected in real time immediately when each user accesses the online site and takes each action. Also, the behavior data may be collected in the form of a stream, and may then be subjected to preprocessing.

The behavior data on which the preprocessing has been completed may be utilized to create a purchase probability model at step S404, generate purchase intention profiles at step S406, and calculate purchase probabilities at step S408.

Here, the purchase probability model may be created by extracting behavior permutations based on continuous actions included in the behavior data and by matching the extracted behavior permutations with purchase results depending on the continuous actions.

The purchase probability model created in this way may be compared with the collected behavior data, and thus purchase probabilities may be calculated.

Further, the purchase intention profiles may be generated using both item information about multiple items, acquired from an item DB 400 associated with the online site, and the behavior data.

Next, the purchase intentions of the users may be detected by combining the purchase intention profiles with the purchase probabilities at step S410.

That is, the purchase intentions of the users may include purchase intention profiles and purchase probabilities.

Thereafter, pieces of demand forecast data for respective items and pieces of demand forecast data for respective regions may be generated using the purchase intention profiles and the purchase probabilities included in the purchase intentions at steps S412 and S414.

For example, the pieces of demand forecast data for respective items may be data indicating how many users have purchase intentions for each of multiple items, and the pieces of demand forecast data for respective regions may be data indicating how many users have purchase intentions in each of multiple regions.

Next, marketing management data, which includes pieces of purchase probability data for respective regions corresponding to each of multiple items, may be generated based on the pieces of demand forecast data for respective items and the pieces of demand forecast data for respective regions.

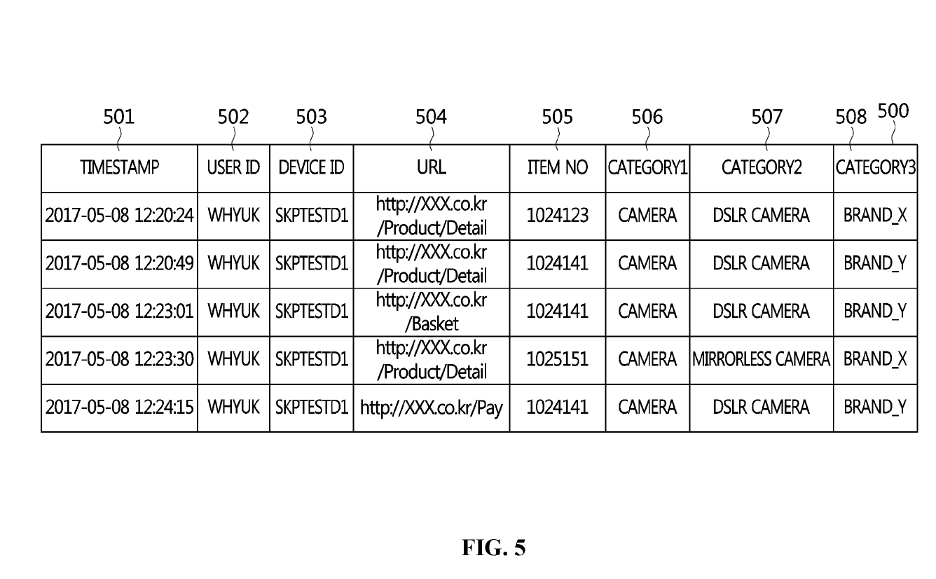

FIG. 5 is a diagram illustrating examples of behavior data collected according to the present invention.

Referring to FIG. 5, behavior data 500 collected according to the present invention may include information related to a behavior timestamp field 501, a user ID field 502, a terminal (device) ID field 503, a URL field 504, an item number field 505, and category fields 506, 507, and 508.

The behavior timestamp field 501 may indicate the time at which the corresponding behavior data is generated.

The user ID field 502 may indicate an identifier for identifying the corresponding user on the online site. For example, when the user subscribes to the online site, the user ID may be an ID registered at the time of subscription, whereas when the user does not subscribe to the online site, the user ID may be an identifier generated based on the access information of the user.

The terminal (device) ID field 503 may indicate an identifier for identifying a device which is used by the user to access the online site.

The URL field 504 may indicate the page address of the online site accessed by the user.

For example, ‘http://xxx.co.kr/Product/Detail’ illustrated in FIG. 5 may be a page including details of each item, ‘http://xxx.co.kr/Basket’ may be a shopping cart page, and ‘http://xxx.co.kr/Pay’ may be a payment page.

Here, the item number field 505 may indicate an identification number or an identifier for identifying an item on the current page accessed by the user.

The category fields 506, 507, and 508 may indicate pieces of category information related to an item corresponding to the item number field 505.

Here, the behavior data may be divided into category levels, as illustrated in FIG. 5, and may then include pieces of category information for respective levels.

For example, the first category field 506 illustrated in FIG. 5 may indicate the field of an item, such as ‘camera’, and may indicate a category that is conceptually more inclusive than that of the second category field 507, indicating the detailed category of the item, such as ‘camera type’. The second category field 507 may indicate a category that is conceptually more inclusive than that of the third category field 508, indicating detailed information of the item, such as ‘camera brand’.

Here, the behavior data according to the embodiment of the present invention may be collected so as to include various types of information in addition to the above-described examples, and the type of information to be included in the behavior data is not particularly limited.

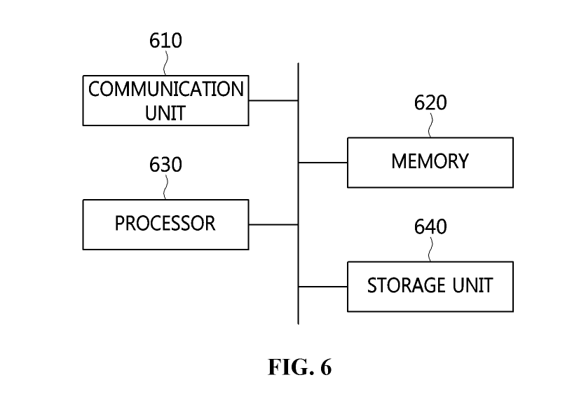

FIG. 6 is a block diagram illustrating a server for providing marketing management data according to an embodiment of the present invention.

Referring to FIG. 6, the server for providing marketing management data according to the embodiment of the present invention includes a communication unit 610, memory 620, a processor 630, and a storage unit 640.

The communication unit 610 functions to transmit and receive information needed to provide marketing management data over a communication network, such as a typical network. In particular, the communication unit 610 according to the present invention may receive data about the online behavior of each user from a separate server for operating an online site.

The memory 620 stores respective purchase intentions which are detected in real time for multiple users who access the online site.

The present invention is intended to detect items to be purchased or the types of items and probabilities that the corresponding items will be purchased, before the multiple users who access the online site actually purchase respective items. For this function, there is a need to detect the purchase intentions of the users before the users purchase the corresponding items.

Here, the purchase intentions may include purchase intention profiles corresponding to the features of respective items desired to be purchased by the multiple users and respective purchase probabilities of the multiple users.

The purchase intention profiles according to the present invention may contain the results of analysis of brand characteristics, keyword characteristics, and price range characteristics according to the present invention, and may then be used to analyze association between the items.

Also, the purchase probabilities according to the present invention may be calculated as high values when each user takes continuous meaningful actions.

Such a purchase intention may be detected at each moment at which the corresponding user searches for an item through the online site. Therefore, the purchase intentions detected in this way may be analyzed and provided in advance before the user actually takes each purchase activity.

Here, in order to detect the purchase intentions, the processor 630 may collect behavior data of the multiple users on the online site for each user.

The behavior data may be related to online actions taken by multiple users who access the online site.

For example, the online behavior may include explicit actions, such as the actions of clicking an item, reading item reviews, addition to or deletion from a shopping cart, attempting to make a payment, entering a keyword, clicking an advertisement, and the social activity of clicking the “like” button or sharing a specific page. Further, the online behavior may also include all implicit actions considered to have a possibility of forming a basis for inferring items of interest, such as user experience (UX)-related actions including a mouse wheel control or swipe-out action, or the action of staying on a specific page for a long period of time or revisiting the same item page or a similar category page. However, the online behavior is not limited to those examples.

Here, the behavior data may be collected in real time immediately when the user accesses the online site and takes actions. Further, the behavior data may be collected in the form of a stream, and may be subjected to a preprocessing procedure for enabling the behavior data to be processed as data having the format needed to detect the purchase intention of the user.

That is, all actions taken by each user who accesses the online site may be collected in real time in accordance with behavior data.

The server according to the embodiment of the present invention may use the real-time online behavior (actions) of the user, as described above. That is, unlike a conventional scheme, in which an item expected to be purchased by the user is determined or in which a purchase probability for the item is predicted using the past purchase records or profile information of the user, the present invention may infer an item or a category having a strong possibility of being purchased by the user in the near future based on a behavior pattern, such as that indicating which page is currently being visited by the user within the e-commerce site currently accessed by the user. By means of this scheme, it is possible to more accurately detect the purchase intention of the user who currently accesses the online site than when using the conventional scheme.

The behavior data collected in real time may include the time at which each online action is taken, an ID for identifying the user or the user terminal, a URL visited by the user, item-related information, etc. The item-related information may include an item number or category information for identifying the corresponding item. The item-related information may also include meta-information, such as item prices or options and keywords entered by the user to search for the items, by which the degree of importance of online behavior can be determined.

Here, the paths through which the behavior data is collected are not limited to a specific path. For example, the behavior data corresponding to the online behavior of the user may be collected in real time through any of various paths, such as a mobile website, a mobile application, and a PC website.

In addition, the behavior data according to the present invention may be received in such a way that the server according to the embodiment of the present invention unifies and receives all behavior data, or in such a way that some terminals aggregate behavior data generated thereby and transfer the aggregated behavior data in a simplified form to the server. Here, the method for collecting the behavior data is not particularly limited to any specific method.

Here, a purchase probability model created based on the behavior permutations may be compared with the behavior data, and thus the respective purchase probabilities of multiple users may be calculated.

The purchase probability model may be a purchase probability model for the corresponding online site. That is, patterns may be extracted from behavior permutations collected from the online site, and the frequency at which a purchase occurs or a non-purchase occurs in the extracted patterns may be analyzed, and thus the purchase probability model may be created based on the results of analysis of the frequency.

Therefore, the behavior data collected in accordance with the user is compared with a purchase pattern or a non-purchase pattern included in the purchase probability model, and thus whether the user will purchase the corresponding item may be calculated as a probability.

Here, behavior permutations may be generated to correspond to the continuous actions extracted based on the behavior data.

The behavior permutations may be generated by arranging pieces of behavior data collected for respective users in temporal sequence depending on various criteria.

For example, it may be assumed that pieces of behavior data collected from user A are arranged depending on the item as a criterion. In this case, a behavior permutation may be generated by arranging only pieces of behavior data related to a specific item B, among pieces of behavior data that are collected when the user A takes continuous actions, in temporal sequence.

Further, when pieces of behavior data are arranged depending on the category as a criterion in the above example, a behavior permutation may also be generated by arranging only pieces of behavior data related to a specific category C, among the pieces of behavior data that are collected when the user A takes continuous actions, in temporal sequence.

Here, the behavior permutation may be generated by arranging Uniform Resource Locators (URLs) corresponding to continuous actions in temporal sequence.

For example, it may be assumed that the user accesses an e-commerce site having an address (URL) corresponding to ‘http://xxx.com’ and takes online actions. In this case, when the user sequentially navigates from a main page to an item detail page, a shopping cart page, and a payment page, a behavior permutation corresponding to (http://xxx.com/main)-(http://xxx.com/item/detail)-(http://xxx.com/basket)-(http://xxx.com/pay) may be generated.

Here, respective URLs corresponding to continuous actions may be converted into and represented by separate identifiers in order to simplify the indication and processing of behavior permutations.

In the above example, ‘http://xxx.com/main’ may be converted into URL_1, ‘http://xxx.com/item/detail’ may be converted into URL_2, ‘http://xxx.com/baskef may be converted into URL_3, and http://xxx.com/pay’ may be converted into URL_4, and thus the resulting URLs may be indicated.

Here, a behavior permutation may be generated for each session which is based on a time point at which the user accesses the online site.

In an example, a period from a time point at which the user logs in to the online site to a time point at which the user logs out from the online site may be determined to be a single session. Behavior data for online actions taken in the corresponding session may be collected, and thus a behavior permutation may be generated.

In another example, a period from a time point at which the user accesses the online site to a time point at which the user leaves the online site may be determined to be a single session, and thus a behavior permutation may be generated based on the session.

The start and end of a single session may not be limited to specific time points, but may be set to various time points.

Here, the purchase probability model may be created by matching purchase results corresponding to continuous actions with behavior permutations.

For example, the purchase probability model may be created by extracting a purchase pattern and a non-purchase pattern based on the behavior permutation of continuous actions that frequently occur when a purchase is made by multiple users who use the corresponding online site, or based on the behavior permutation of continuous actions that frequently occur when a purchase is not made by the multiple users. In this case, a behavior permutation, for which the total number of occurrences of continuous actions in each pattern does not reach a predetermined number, is excluded from the creation of the purchase probability model, and thus the computing speed at which the purchase probability model is created may be improved.

Here, respective purchase intention profiles of the multiple users may be generated based on the pieces of item information corresponding to multiple items, stored in an item DB, and the behavior data.

The item DB may store item information about multiple items registered on the online site accessed by each user. For example, detailed information related to respective items, such as item names, item categories, and item prices, may be stored in accordance with the item information.

Therefore, information about an item, for which the user is determined to have a purchase intention based on the behavior data, may be acquired from the item DB, and a purchase intention profile may then be generated from the item information.

Here, purchase intention profiles may contain, but are not limited to, information such as a search term, a keyword, a brand, and a price range for the corresponding item.

Further, the purchase intention profiles may contain weights to be applied to the determination of a purchase intention in consideration of the URLs visited by each user based on the behavior data. For example, when the URL of the page visited by the user is the URL of a page in which the corresponding item is to be purchased, a weight may be applied to the purchase page, compared to the case where the URL of the page visited by the user is the URL of the main page of the online site. That is, when the user navigates to the payment page for paying for a specific item, it may be determined that the user definitely has an intention to purchase the specific item, and a weight may be applied to the payment page.

Also, at least one of purchase probabilities for respective items and purchase probabilities for respective item categories may be calculated based on the purchase probabilities that match the purchase intention profiles.

Further, the server according to the embodiment of the present invention may provide user distributions for respective purchase probabilities for a specific item or a specific category based on purchase probabilities of respective users, purchase probabilities for respective items, and purchase probabilities for respective item categories which are included in purchase intentions.

The processor 630 generates demand forecast data, in which items and regions are taken into consideration, based on pieces of user information and purchase intentions of multiple users.

Here, information about respective destinations of the multiple users may be acquired from the user information, and at least one of pieces of demand forecast data for respective items and pieces of demand forecast data for respective regions may be generated using the purchase intention profiles, the purchase probabilities, and the destination information.

For example, the pieces of demand forecast data for respective items may be data indicating how many users have purchase intentions for each of multiple items, and the pieces of demand forecast data for respective regions may be data indicating how many users have purchase intentions in each of multiple regions.

The user information may be acquired from a separate DB which stores user information on the online site.

Further, the processor 630 generates and provides, based on the demand forecast data, marketing management data for optimizing distribution and logistics of multiple items provided by the online site.

Here, the marketing management data may include pieces of purchase probability data for respective regions corresponding to each of multiple items, wherein the purchase probability data may be generated based on the pieces of demand forecast data for respective items and the pieces of demand forecast data for respective regions. Since the pieces of purchase probability data for respective regions corresponding to each of multiple items may include destination information, demand in respective regions for the corresponding item may be forecasted when the purchase probabilities are divided according to region.

Therefore, the marketing management data may be provided to individual item sellers based on the online site, thus allowing the sellers to effectively perform inventory management for items having a high purchase probability. Further, the distribution and logistics of items may be optimized in terms of purchase probabilities for respective regions or demand for respective regions such that the distribution and logistics of the items are not disrupted.

As described above, the storage unit 640 may support a function of providing marketing management data according to the embodiment of the present invention. Here, the storage unit 640 may function as a separate large-capacity storage and may include a control function for performing operations.

Meanwhile, the server may store information in memory installed therein. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard disk device, an optical disk device, or any other kind of large-capacity storage device.

By utilizing such a server, an item to be purchased by each user or the purchase intention of the user, such as a purchase probability, may be detected before the user takes a purchasing activity via Internet e-commerce.

Further, demand for items, provided via Internet e-commerce, may be forecasted for respective item types or regions.

Furthermore, a process for distribution and logistics may be optimized by forecasting demand for items.

In addition, Internet e-commerce may be supported so that an Internet e-commerce seller can desirably manage inventory or manage the supply and demand of products.

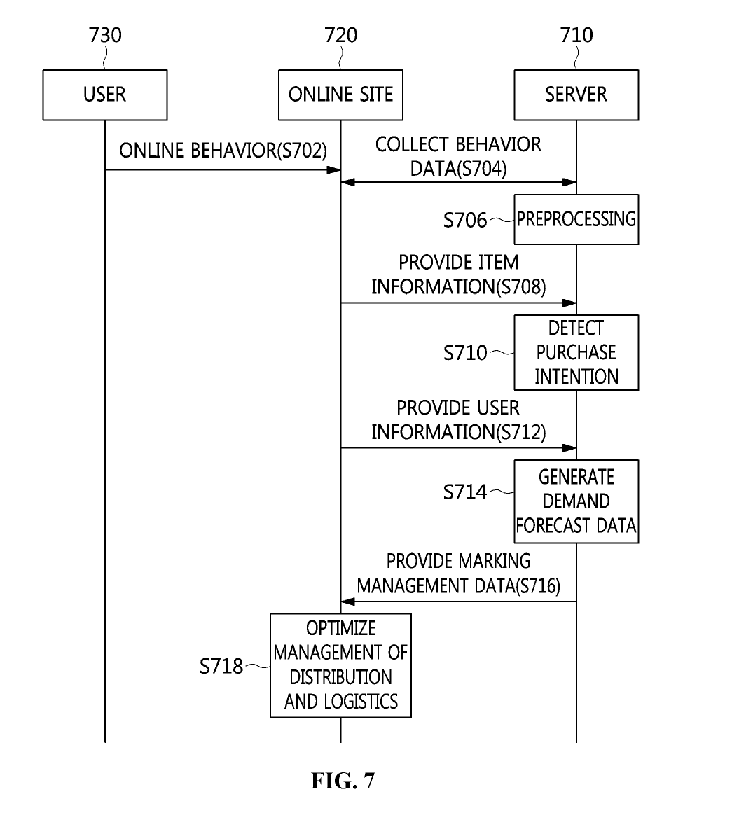

FIG. 7 is a diagram illustrating another example of a process for providing marketing management data according to the present invention.

Referring to FIG. 7, in the process for providing marketing management data according to the present invention, when a user 730 accesses an online site 720 and engages in online behavior at step S702, a server 710 may collect behavior data in accordance with the online behavior of the user at step S704.

Thereafter, the server 710 may perform preprocessing on the collected behavior data at step S706, receive item information about multiple items from the online site 720 at step S708, and detect the purchase intention of the user 730 at step S710.

For example, the online behavior may include explicit actions, such as the actions of clicking an item, reading item reviews, addition to or deletion from a shopping cart, attempting to make a payment, entering a keyword, clicking an advertisement, and the social activity of clicking the “like” button or sharing a specific page. Further, the online behavior may also include all implicit actions considered to have a possibility of forming a basis for inferring items of interest, such as user experience (UX)-related actions including a mouse wheel control or swipe-out action, or the action of staying on a specific page for a long period of time or revisiting the same item page or a similar category page.

Here, the purchase intentions of users may include purchase intention profiles, corresponding to features of respective items desired to be purchased by multiple users, and respective purchase probabilities of the multiple users.

Such a purchase intention may be detected at each moment at which the corresponding user searches for an item on the online site.

Thereafter, the server 710 may be provided with user information from the online site 720 at step S712, and may generate demand forecast data based on the user information and the purchase intention at step S714.

Here, information about respective destinations of the multiple users may be acquired from the user information, and at least one of pieces of demand forecast data for respective items and pieces of demand forecast data for respective regions may be generated using the purchase intention profiles, the purchase probabilities, and the destination information.

Thereafter, the server 710 may generate marketing management data for optimizing distribution and logistics of multiple items provided by the online site 720 based on the demand forecast data, and may provide the marketing management data to the online site 720 at step S716.

Here, the marketing management data may include pieces of purchase probability data for respective regions corresponding to each of multiple items, wherein the purchase probability data may be generated based on the pieces of demand forecast data for respective items and the pieces of demand forecast data for respective regions.

Next, in the online site 720, the management of distribution and logistics of multiple items registered on the online site 720 may be optimized based on the marketing management data at step S718, and thus a system for e-commerce may be efficiently operated.

Here, since the pieces of purchase probability data for respective regions corresponding to each of multiple items may contain destination information, demand in respective regions for the corresponding item may be forecasted when the purchase probabilities are divided according to region.

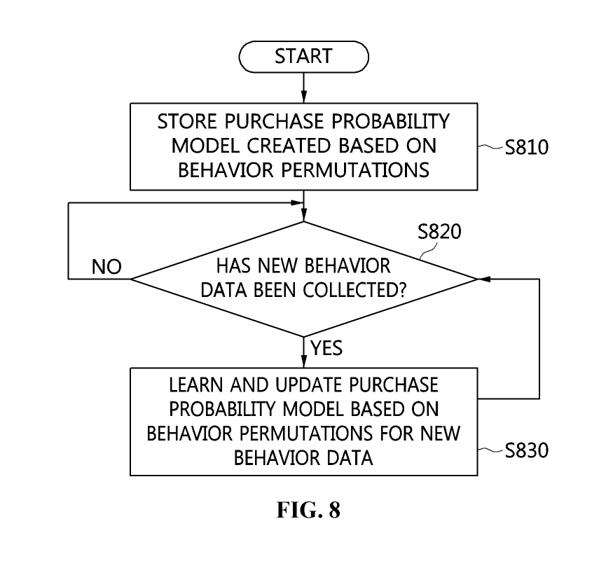

FIG. 8 is a diagram illustrating an example of a procedure for learning a purchase probability model in the marketing management data provision method according to an embodiment of the present invention.

Referring to FIG. 8, the procedure for learning a purchase probability model in the marketing management data provision method according to the embodiment of the present invention may store the purchase probability model created based on behavior permutations at step S810.

Here, the purchase probability model may be stored in memory included in the server or a separate database (DB).

Thereafter, whether new behavior data has been collected may be determined based on the online behavior of a user at step S820.

If it is determined at step S820 that new behavior data has been collected, the purchase probability model may be learned and updated based on a behavior permutation for the new behavior data at step S830.

That is, a pattern, extracted from the behavior permutation for the new behavior data, and purchase results, corresponding to the pattern, may be reflected in the purchase probability model, and thus the purchase probability model may be updated.

Thereafter, the process returns to step S820 of determining where new behavior data has been collected, and then continuing to learn and update the purchase probability model.

Here, the new behavior data may be collected through online actions taken by all users who access the online site.

If it is determined at step S820 that new behavior data has not been collected, step S820 may be repeatedly performed until new behavior data is collected.

That is, the purchase probability model may be continuously updated until the use of the online site is interrupted so as to update or manage the server.

The learning and update of the purchase probability model may be continuously performed in this way, and thus the reliability and accuracy of marketing management data provided through the online site may be improved.

The functional operations and implementations of the subject matter described herein may be implemented as digital electronic circuitry, or may be implemented in computer software, firmware, or hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium in order to control the operation of a processing system or to be executed by the processing system.

The computer-readable medium may be a machine-readable storage device, a machine-readable storage substrate, a memory device, a composition of material that affects a machine-readable radio-wave-type signal or one or more combinations thereof.

As used herein, the terms “system” or “device” include all kinds of apparatuses, devices and machines for processing data, which include, for example, a programmable processor and a computer, or multiple processors and a computer. In addition to hardware, the processing system may also include, for example, code that configures processor firmware, and code that configures an execution environment for computer programs in response to a request from a protocol stack, a database management system, an operating system, or one or more combinations thereof.

A computer program (also known as a program, software, a software application, a script or code) may be written in any form of programming language including a compiled or interpreted language, or an a priori or procedural language, and may be deployed in any form including standalone programs or modules, components, subroutines, or other units suitable for use in a computer environment. The computer program does not necessarily correspond to a file in a file system. The program may be stored in a single file provided to the requested program, in multiple interactive files (for example, files storing one or more modules, subprograms or portions of code), or in a part of a file containing other programs or data (for example, one or more scripts stored in a markup language document). The computer program may be located on a single site or distributed across multiple sites such that it is deployed to run on multiple computers interconnected by a communications network or on a single computer.

The computer-readable medium suitable for storing computer program instructions and data may include, for example, semiconductor memory devices, such as EPROM, EEPROM and flash memory devices, all types of nonvolatile memory, including magnetic disks, such as internal hard disks or external disks, magnetic optical disks, CD-ROMs and DVD-ROMs, media, and memory devices. A processor and memory may be supplemented by special-purpose logic circuits, or may be integrated therewith.

Implementations of the subject matter described herein may be realized on an arithmetic system including, for example, a back-end component such as a data server, a middleware component such as an application server, a front-end component such as a client computer with a web browser or a graphical user interface through which a user may interact with the implementations of the subject matter described herein, or one or more combinations of the back-end component, the middleware component, and the front-end component. The components of the system may be interconnected using any form or medium of digital data communication such as a communication network.

While the present invention includes a number of specific implementation details, they should not be construed as limitations on the scope of the invention or the claimable scope, but should be understood as a description of features that may be specific to particular embodiments of the invention. Similarly, the specific features described herein in the context of individual embodiments may be implemented by being combined in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may be excluded from the combination in some cases, and the claimed combination may be altered to a sub-combination or variation thereof.

Also, while this specification illustrates operations in the drawings in a particular order, it should not be understood that such operations must be performed in the particular order or the sequential order shown in the drawings in order to obtain a desired result, or that all of the illustrated operations should be performed. In certain cases, multitasking and parallel processing may be advantageous. Also, separation of the various system components of the above-described embodiment should not be understood as requiring such separation in all embodiments, and it should be understood that the program components and systems described above may generally be integrated into a single software product or packaged into multiple software products.

In accordance with the present invention, the purchase intention of each of multiple users who access an online site may be detected in real time, demand forecast data in which items and regions are taken into consideration may be generated based on user information and purchase intention of each of the multiple users, and marketing management data for optimizing distribution and logistics of the multiple items provided by the online site may be generated and provided based on the demand forecast data. Also, in accordance with the present invention, a distribution and logistics process based on Internet e-commerce may be optimized, thus allowing each seller to more desirably operate the online site.

In accordance with the present invention, an item to be purchased by a user or the purchase intention of the user, such as a purchase probability, may be detected before the user takes a purchasing activity via Internet e-commerce.

Further, the present invention may forecast demand for items, provided via Internet e-commerce, for respective item types or regions.

Furthermore, the present invention may optimize a process for distribution and logistics by forecasting demand for items.

In addition, the present invention may support Internet e-commerce so that an Internet e-commerce seller can desirably manage inventory or manage the supply and demand of products.

In addition, the present invention may provide pieces of demand forecast information for respective items, and may then be utilized in various fields, such as more active marketing, personalized and targeted advertising, and item recommendation.

This specification is not intended to limit the present invention to the specific terms disclosed herein. Although the present invention has been described in detail with reference to the above examples, those skilled in the art may conceive alternations, modifications, and variations on these examples without departing from the scope of the present invention. The scope of the present invention is defined by the appended claims rather than the description, and it should be construed that all alternations and modifications derived from the meaning and scope of the appended claims and their equivalents are included within the scope of the present invention.

What is claimed is:

1. A method for providing marketing management data, comprising:
detecting, in real time, respective purchase intentions of multiple users who access an online site;
generating demand forecast data, in which items and regions are taken into consideration, based on respective pieces of user information and the purchase intentions of the multiple users; and
generating and providing marketing management data for optimizing distribution and logistics of multiple items provided by the online site, based on the demand forecast data.

2. The method of claim 1, wherein the purchase intentions comprise purchase intention profiles, corresponding to features of respective items desired to be purchased by the multiple users, and respective purchase probabilities of the multiple users.

3. The method of claim 2, wherein detecting the purchase intentions comprises:
collecting respective pieces of behavior data of the multiple users on the online site;
calculating respective purchase probabilities of the multiple users by comparing a purchase probability model, created based on the behavior permutations, with the behavior data; and
generating respective purchase intention profiles of the multiple users based on an item database, in which pieces of item information corresponding to the multiple items are stored, and the behavior data.

4. The method of claim 3, wherein detecting the purchase intentions further comprises:
generating the behavior permutations to correspond to continuous actions extracted based on the behavior data; and
creating the purchase probability model by matching purchase results depending on the continuous actions with the behavior permutations.

5. The method of claim 2, wherein generating the demand forecast data is configured to acquire information about respective destinations of the multiple users based on the user information and to generate at least one of pieces of demand forecast data for respective items and pieces of demand forecast data for respective regions using the purchase intention profiles, the purchase probabilities, and the destination information.

6. The method of claim 3, wherein detecting the purchase intentions further comprises calculating at least one of purchase probabilities for respective items and purchase probabilities for respective item categories based on purchase probabilities that match the purchase intention profiles.

7. The method of claim 4, wherein generating the behavior permutations is configured to generate the behavior permutations by arranging Uniform Resource Locators (URLs) corresponding to the continuous actions in temporal sequence.

8. The method of claim 5, wherein the marketing management data comprises pieces of purchase probability data for respective regions corresponding to each of the multiple items, the purchase probability data being generated based on the pieces of demand forecast data for respective items and the pieces of demand forecast data for respective regions.

9. A server, comprising:
memory for storing respective purchase intentions that are detected in real time for multiple users who access an online site; and
a processor for generating demand forecast data, in which items and regions are taken into consideration, based on respective pieces of user information and respective purchase intentions of the multiple users, and for generating and providing marketing management data for optimizing distribution and logistics of multiple items provided by the online site, based on the demand forecast data.

10. The server of claim 9, wherein the purchase intentions comprise purchase intention profiles, corresponding to features of respective items desired to be purchased by the multiple users, and respective purchase probabilities of the multiple users.
